(19) United States
(12) Patent Application Publication
(10) Pub. No.: US 2013/0096771 A1
(43) Pub. Date: Apr. 18, 2013

(54) APPARATUS AND METHOD FOR CONTROL OF PRESENTATION OF MEDIA TO USERS OF A VEHICLE

(71) Applicant: Ed Srenger, Schaumburg, IL (US)

(72) Inventor: Ed Srenger, Schaumburg, IL (US)

(73) Assignee: CONTINENTAL AUTOMOTIVE SYSTEMS, INC., Deer Park, IL (US)

(21) Appl. No.: 13/271,402

(22) Filed: Oct. 12, 2011

(51) Int. Cl. G06F 19/00

(52) U.S. Cl. 701/36

(57) ABSTRACT

A vehicle includes or is provided with a vehicular service. One or more communications are received from one or more occupants of a vehicle. The identity of the one or more occupants that made the communications is determined. It is also determined whether the vehicle is moving. When the occupant is identified as a driver and when the vehicle is moving, the driver is prevented from using the vehicular service when interaction with the vehicular service would result in driver distraction. When the occupant is identified as a non-driver and when the vehicle is moving, the non-driver is allowed to utilize the vehicular service.

### FIELD OF THE INVENTION

The invention relates generally to presentation of media in vehicles to users and, more specifically, allowing or not allowing presentations under various conditions to one or more of these users.

### BACKGROUND OF THE INVENTION

Vehicles are often equipped with a variety of systems to aid a driver who is driving the vehicle, provide entertainment for vehicle occupants (including the driver and passengers), or for other purposes. For instance, navigation systems, radios, music players (e.g., CD players), and hands-free communication systems are installed in vehicles for various purposes.

Unfortunately, when drivers attempt to use these functions while at the same time operating the vehicle, significant problems can occur. For example, when a driver is driving in heavy traffic and is also attempting to, for example, change the settings of one of these systems, they may lose their focus on driving and become involved in an accident. Even a momentary distraction can result in undesirable or harmful consequences.

To prevent driver distraction, some previous systems have ensured that various in-vehicle features are not accessible to drivers while the vehicle is in motion. Specifically, some previous systems have made pairing a Bluetooth (BT) phone, introducing a destination by hand on a navigation system, or selecting a music item from the touch display unavailable when the vehicle is not fully stopped. At the same time, these previous safety features prevent other vehicle occupants from accessing the full functionality of the installed applications.

In fact, the other occupants of the vehicle can most often still engage these features without creating undesirable results. However, since previous approaches did not discriminate between drivers or non-drivers in terms of feature suppression, non-drivers were sometimes inconvenienced, made uncomfortable, or otherwise disadvantaged by the operation of the previous systems.

### BRIEF DESCRIPTION OF THE DRAWINGS

The present invention is illustrated, by way of example and not limitation, in the accompanying figures, in which like reference numerals indicate similar elements, and in which:

FIG. 1 comprises a flowchart of one approach for reducing driver distraction according to various embodiments of the present invention;

FIG. 2 comprises a flowchart of another approach for reducing driver distraction according to various embodiments of the present invention;

FIG. 3 comprises a block diagram of an apparatus for reducing driver distraction in a vehicle according to various embodiments of the present invention; and

FIG. 4 comprises a diagram showing one example of placement of microphones in a vehicle such as a car according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

In the approaches described herein, selected vehicle occupants are able to utilize vehicular services even when these services may be prohibited from being used by the driver (or other selected occupants) of the vehicle. These approaches allow vehicle occupants to selectively utilize and/or operate various vehicular systems while at the same time providing for the safety of all occupants of the vehicle.

In many of these embodiments, a vehicle includes or is provided with a vehicular service. One or more communications are received from one or more occupants of the vehicle. The identity of the one or more occupants that made the communications is determined. It is also determined whether the vehicle is moving. When the occupant is identified as the driver and when the vehicle is moving, the driver is prevented from using the vehicular service when completing the task would result in driver distraction. However, when the occupant is identified as a non-driver and when the vehicle is moving, the non-driver is allowed to fully utilize the vehicular service.

In some aspects, the voice signals may be received from a plurality of microphones and the identity of the occupant is determined based at least in part upon the origination of the voice signals. By “origination” it is meant the identified source of the voice signals such as the driver or a particular occupant. As will be described elsewhere herein, various approaches may be used to determine the source of the signals. In other aspects, the communication is received from a plurality of microphones and the identity of the occupant is determined using a speaker identification approach that analyzes the content of the voice signals.

In yet other aspects, information is presented to the non-driver on a display when the non-driver is allowed to use vehicular services. The vehicular service may be a service such as a voice communication service, a navigation system service, an information display service, a music selection service, or some other type of entertainment service. Other examples of services are possible.

In some other aspects, when the occupant is identified as a driver and the vehicle is not moving, the driver is allowed to use the vehicular service. In other aspects, a subsequent determination is made that the vehicle is again moving and when the occupant is identified as a driver, the driver is prevented from using the vehicular service when completing the task would result in driver distraction.

In others of these embodiments, a voice command is received from a user of a vehicle. A determination is made at the User Interface level as to whether the received voice command requires the user to take his focus away from driving in order to complete a transaction. In this case, the user, in addition to providing the initial voice commands, would need to manually confirm or select an option by voice by glancing at displayed messages. This interaction is a complex physical response of the user as the user may be required to use their hands or fingers to move, turn, slide, or otherwise actuate one or more switches that activate or control a device or read through information displayed on a screen and select an option by initiating another voice command A determination is made as to whether the vehicle is moving and the voice command is analyzed to determine whether the user associated with the voice command is a driver of the vehicle. When the vehicle is moving and the command requires the user to manually activate or control a device or read through complex information in order to complete a transaction, and the user is the driver, execution of the voice command is disabled. When the vehicle is moving, the command requires the user to manually activate or control a device or read through complex information in order to complete a transaction, and the user is not the driver, execution of the voice command is allowed.

In some aspects, a determination of the identity of the user is made based at least in part on a signal origination of the voice command. In one example, the voice command comprises determining the identity of the user based at least in part by using a speaker identification approach or system to analyze the content of the voice command. In another example, the task that the occupant is undertaking requires use of or interaction with a service or service module that is deployed in the vehicle. The service may be a voice communication service, a navigation system service, an information display service, or a music presentation service. Other examples of services are possible.

In still others of these embodiments, an apparatus for preventing driver distraction in a vehicle includes an interface and a controller. The interface includes an input and an output. The input is configured to receive at least one communication from at least one occupant in the vehicle and a signal indicative of whether the vehicle is moving. The output is coupled to a vehicular service module. The controller is coupled to the interface and is configured to determine the identity of the at least one occupant that made the at least one communication. The controller is configured to determine whether the vehicle is moving based upon the received signal and is further configured to when the at least one occupant is identified as a driver and the vehicle is moving, send a first signal to the vehicular services module via the output that is effective to prevent the driver from using the vehicular service module, if the interaction would result in driver distraction. The controller is still further configured to determine when the occupant is a driver or non-driver, and when the at least one occupant is identified as a non-driver and the vehicle is moving, send a second signal to the vehicular services module via the output. The second signal is effective to allow the non-driver to utilize the vehicular service module.

In some aspects, the controller is configured to determine the identity of the occupant from voice signals that are received from a plurality of microphones and determine the identity based at least in part on the strength of the voice signals. In other aspects, the controller is configured to determine the identity of the at least one occupant from voice signals received from a plurality of microphones and use a speaker identification approach to determine the identity of the voice signals.

In other aspects, the controller is configured to determine whether the occupant is a driver or a non-driver, and when the occupant is identified as a driver and the vehicle is not moving, send a third signal to the vehicular services module via the output. The third signal is effective to allow the driver to use the vehicular service module. In still other aspects, the controller is configured to subsequently determine that the vehicle is again moving, and when the at least one occupant is identified as a driver and the vehicle is again moving, send a fourth signal to the vehicular services module via the output. The fourth signal is effective to prevent the driver from using the vehicular service module when completing the task would result in driver distraction.

It will be appreciated that although many of the approaches described herein involve selectively disabling vehicular systems for drivers, that these approaches can also be used to selectively disable systems for selected passengers as well. In addition, although these approaches are generally described with respect to passenger vehicles, they can be applied to any type of vehicle including cars, trucks, aircraft, ships, to mention a few examples.

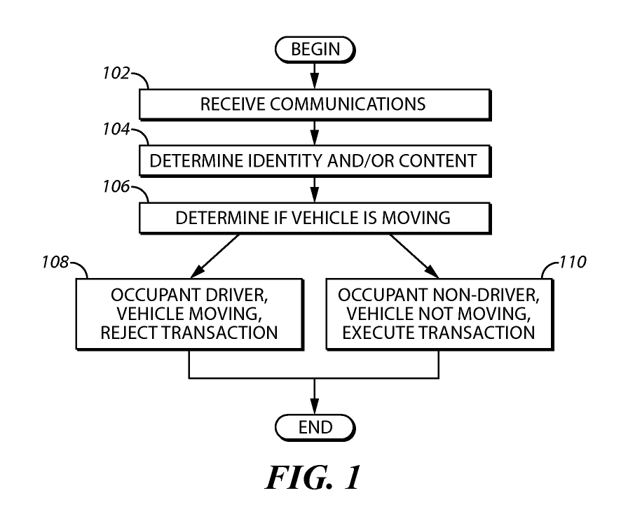

Referring now to FIG. 1, one example of an approach for preventing driver distraction is described. At step 102 one or more communications (e.g., a speech signal) are received from at least one occupant in a vehicle. The communications may be received over any type of wired or wireless communication link. Moreover, the communications can be received from or via any type of device such as a microphone, keypad, touch screen and in this respect may be a voice signal or the actuation of any type of user interface. At step 104, the identity of the at least one occupant that made the at least one communication is determined. In one example, this may be accomplished by determination the origination of the communication. For instance, where four microphones are used in the vehicle (e.g., one for each occupant) it may be determined which microphone has the greatest signal strength and the occupant associated with the microphone having the greatest signal strength is determined to be the originator of the communication. To take one example, if the microphone nearest the driver receives a voice signal and this voice signal is strongest at the microphone situated/associated with the driver, it is determined that the voice signal received has originated with the driver.

At step 106, at is also determined whether the vehicle is moving. For example, various types of sensors (e.g., sensors that measure wheel rotation or acceleration of the vehicle) can be used to determine if the vehicle is moving.

At step 108, when the at least one occupant is identified as a driver and the vehicle is moving, the driver is prevented from using the vehicular service when completing the task would result in driver distraction. The vehicular service may be predetermined (i.e., one or more services or portions of these services may always be disabled regardless of the message content) or the signal may specify a particular service requested by the user. In this respect, any speech recognition approach may be used to determine the content of the received signal. Additionally, a signal may be sent from a control unit that prohibits the driver from using the vehicular service when completing the task would result in driver distraction. To take one example, interfaces used by the driver (e.g., particular switches or buttons) may be disabled by the control signal.

At step 110, when the at least one occupant is identified as a non-driver and the vehicle is moving, the non-driver is allowed to utilize the vehicular service. To take one example, a control signal may be sent to a particular interface (e.g., button, switch, or display) that allows only the occupant to actuate that interface.

As mentioned, in performing steps 108 and 110 and to take one example, control interfaces (e.g., buttons, switches, knobs, and so forth) for various vehicular services may be generally in reach of only certain occupants. For instance, the driver may only have access to certain of these interfaces (e.g., switches that are in reach of the driver without interfering with his or her ability to operate the vehicle). Once a determination is made, selected interfaces may be deactivated. For example, if the vehicle is moving and a driver is identified as a speaker, then interfaces associated with the driver may be deactivated. In other examples, display screens that would be used to display information (if enabled), may be deactivated (e.g., tuned off).

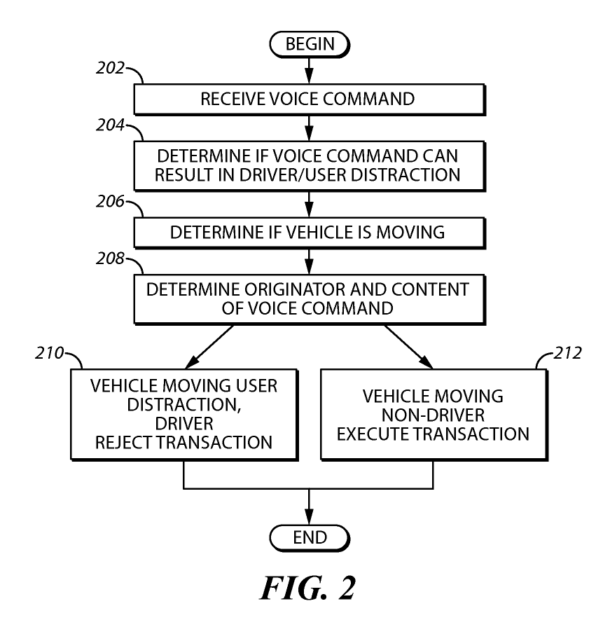

Referring now to FIG. 2, another example of an approach that controls the activation of vehicular services is described. At step 202, a voice command is received from a user of a vehicle. For example, this may be received from microphones disposed at various locations within the vehicle (e.g., one microphone may be disposed in close proximity to each potential occupant such as one microphone can be disposed in front of each potential occupant of the vehicle).

At step 204, it is determined whether the received voice command would require further interaction with the vehicular service, resulting in distraction for the user to complete a task. The interaction is a complex physical response of the user. For example, the completion of the requested task may require the user extend their arms, turn their hands, and have their fingers engage a switch or read information provided on a display and make a selection. One example of such a task is when a user is interested in obtaining a list of points of interest (POI). A voice command is issued requesting, for instance, a list of restaurants. The list in turn is displayed on the Head-Unit's (HU) tactile screen. The user, after reading the information provided on the screen selects the item of interest either by touch or by speaking it out as a voice command.

At step 206, it is determined whether the vehicle is moving. For example, this may be accomplished using various sensors that determine movement such as sensors that determine whether the vehicle transmission is in a driving mode, or whether the wheels are turning to mention two examples. Other implementations are possible. At step 208, the content of the voice signal is analyzed to determine whether the user associated with the voice command is a driver of the vehicle. Additionally, speech recognition approaches can be used to determine the intent of the command. In one approach, multiple microphones are deployed in the immediate vicinity of each of the potential vehicle occupants (i.e., one or more microphones is associated with a particular occupant such as the driver, front passenger, left back passenger, and so forth). Signal strength levels are measured at all microphones for a given communication. The communication is determined to originate with the occupant associated with the microphone having the strongest signal strength.

At step 210, when the vehicle is moving, the command requires an interaction that can result in user distraction, and the user is the driver, execution of the voice command is disabled. For instance, the driver may only have access to certain interfaces for particular vehicular service such as a button on their side of a CD player that can be reached without requiring taking the focus away from operating the vehicle. Once a determination is made, selected interfaces may be deactivated. For example, if the vehicle is moving and a driver is identified as a speaker, then interfaces associated with the driver may be deactivated. In other approaches, the driver may only have access to systems that do not require taking the focus away from operating the vehicle, but the system may deny access to others that result in driver distraction. In still other aspects, other occupants (e.g., children) may be allowed access to some systems, but not to others (whether or not the vehicle is moving).

As mentioned, the deactivation process may include sending a control signal to a vehicular services module that prevents the driver from utilizing the service. To mention a few examples, a display screen normally displaying information to the driver may be deactivated or switches normally usable by the driver may be deactivated. In still another example, an audio message is played out to the driver indicated that such services are disabled.

At step 212, when the vehicle is moving, the command requires an interaction that can result in user distraction, and the user is not the driver, execution of the voice command is allowed. As mentioned, speech recognition approaches may be used to determine the system to be activated (e.g., the CD player) and/or what needs to be done (“turn the volume up”).

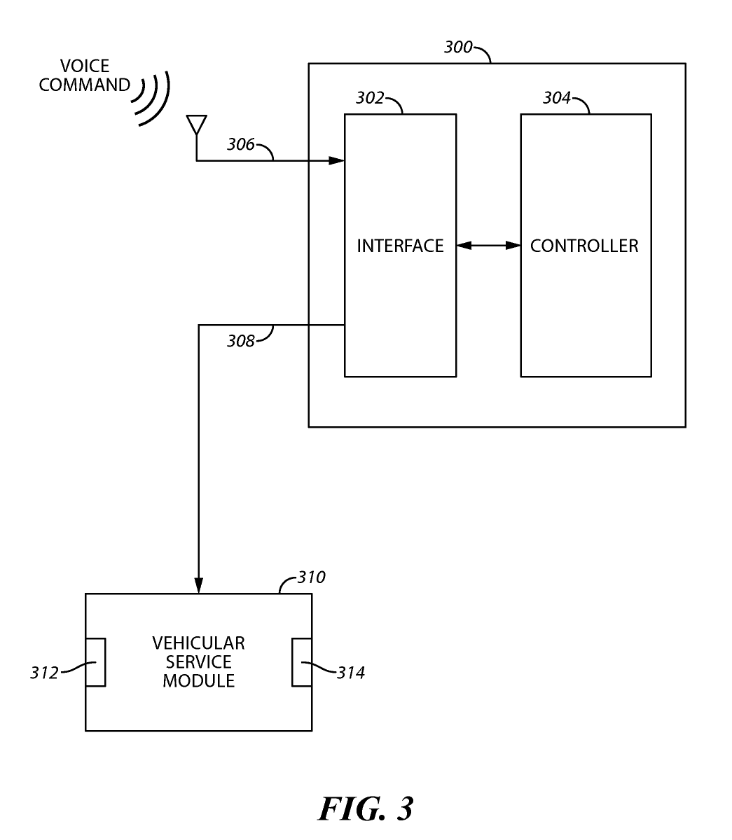

Referring now to FIG. 3, an apparatus 300 for preventing driver distraction in a vehicle includes an interface 302 and a controller 304. The interface 302 includes an input 306 and an output 308. The input 306 is configured to receive at least one communication from at least one occupant in a vehicle and a signal indicative of whether the vehicle is moving. The output 308 is coupled to a vehicular service module 310.

The controller 304 is coupled to the interface 302. The controller 304 is configured to determine the identity of the at least one occupant that made the at least one communication and determine whether the vehicle is moving based upon the signal. The controller 304 is further configured to when the at least one occupant is identified as a driver and the vehicle is moving, send a first signal to the vehicular services module 310 via the output 308 that is effective to prevent the driver from using the vehicular service module. The controller 304 is further configured to when the at least one occupant is identified as a non-driver and the vehicle is moving, send a second signal to the vehicular services module 310 via the output that is effective to allow the non-driver to utilize the vehicular service module 310.

One vehicular service module 310, for instance can be a CD player. First actuators 312 (e.g., switches) may be present on the drivers side of the service 310 while second actuators 314 are present on the passenger side of the service 310. For instance, the driver may only have access to certain of these interfaces. Once a determination is made, selected interfaces may be activated or deactivated. For example, if the vehicle is moving and a driver is identified as a speaker, then interfaces 312 associated with the driver may be deactivated while the other interfaces 314 are activated.

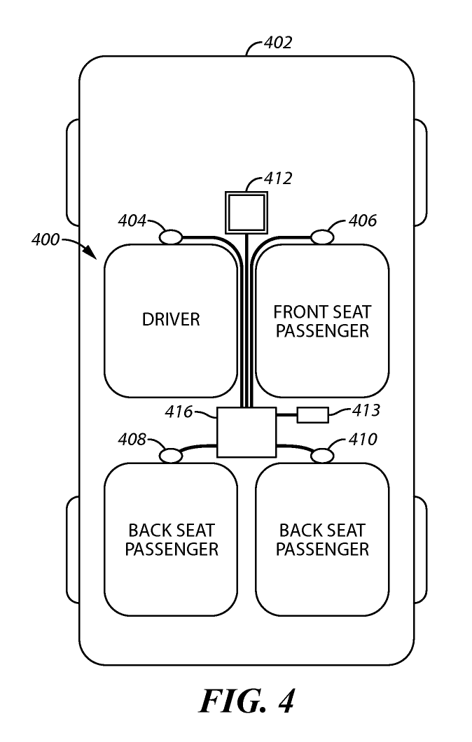

Referring now to FIG. 4, one example of a system 400 includes microphones 404, 406, 408, and 410 that are disposed in a vehicle 402. The microphones 404, 406, 408, and 410 are installed in the vicinity of each vehicle occupant, such as illustrated as shown in FIG. 4. It will be appreciated that other microphone placements can be supported as well. In the example of FIG. 4, two microphones are used for the front seat occupants with one microphone associated with each occupant. As used herein, “associated” refers to a microphone (or other sensor or sensing device) that is physically nearer and/or at least has the greatest chance (compared to the other microphones) of receiving a voice signal from a particular occupant. In the example of FIG. 4, microphone 404 is associated with the driver since the microphone 404 is closest to the driver and it is likely that the strongest signal received is from the driver. The microphone 406 is associated with the front seat passenger; the microphone 408 is associated with the left rear seat passenger; and the microphone 410 is associated with the right rear seat passenger. The system 400 includes a controller 416 that is coupled to a display 412 and the microphones as well as other service modules.

Upon a voice activation button press by the driver (e.g., by actuating a switch 413), the controller 416 enters a speech recognition listening mode where all microphones 404, 406, 408, and 410 are active. If the driver issues a voice command requiring an interaction taking the focus away from operating the vehicle while the vehicle is moving (e.g., entering a pin code to pair a mobile phone, or confirming a destination by hand on a HU display 412, the controller 416 will provide a standard UI error message (“function not available while vehicle in motion”), for example by means of a played out recorded or synthesized audio prompt. If however, any of the other occupants issue a voice command the full functionality of the user interface is unlocked. In one example, identification of the active microphone associated with the speaker is achieved by means of a maximum signal-to-noise ratio (SNR) based speech detection algorithm.

Various voice detection approaches can be implemented at the controller 416 to determine the identity of a speaker. These approaches may include any signal processing technique that take advantage of the strength of the audio signal or spatial selectivity and side interference cancellation, such as implemented in adaptive beamforming algorithms. In a four microphone configuration, if back seat occupants carry on a conversation, the beamforming technology would still enable the front-seat passenger to interact with the system. Once the driver has initiated a voice command that could result in driver distraction there still could be an attempt by the driver to interact with the system while the vehicle is in motion. Touch screen display approaches could be used that block the viewing of information from the driver's position, while enabling the front seat passenger to view and select by touch a displayed item (e.g., only from the passenger's seating position could the information then be viewed). For the phone pairing use case, it is assumed that the Bluetooth (BT) phone to be paired to the vehicle system would be in the possession of a vehicle occupant, other than the driver. In one example, the ability for the occupants other than the driver to interact with vehicular services and complete tasks initiated by the driver can be implemented on any in-vehicle system equipped with automatic speech recognition (ASR) and at least two microphones.

It will be understood that the functions described herein may be implemented by computer instructions stored on a computer media (e.g., in a memory) and executed by a processing device (e.g., a microprocessor, controller, or the like).

It is understood that the implementation of other variations and modifications of the present invention and its various aspects will be apparent to those of ordinary skill in the art and that the present invention is not limited by the specific embodiments described. It is therefore contemplated to cover by the present invention any modifications, variations or equivalents that fall within the spirit and scope of the basic underlying principles disclosed and claimed herein.

What is claimed is:

1. A method of preventing driver distraction in a vehicle, the vehicle providing a vehicular service, the method comprising:
receiving at least one communication from at least one occupant in a vehicle;
determining the identity of the at least one occupant that made the at least one communication;
determining whether the vehicle is moving;
when the at least one occupant is identified as a driver, the vehicle is moving, and when the communication could result in driver distraction, preventing the driver from using the vehicular service;
when the at least one occupant is identified as a non-driver and the vehicle is moving, allowing the non-driver to utilize the vehicular service.

2. The method of claim 1 wherein receiving at least one communication comprises receiving voice signals from a plurality of microphones and wherein determining the identity of the at least one occupant comprises determining the identity based at least in part on the origination of the voice signals.

3. The method of claim 1 wherein receiving at least one communication comprises receiving voice signals from a plurality of microphones and wherein determining the identity of the at least one occupant comprises using a speaker identification approach and using a voice recognition approach to determine the content of the voice signals.

4. The method of claim 1 wherein allowing the user to utilize the vehicular service comprises presenting information to the non-driver on a display.

5. The method of claim 1 wherein the vehicular service is a service selected from the group consisting of: a voice communication service; a navigation system service; an information display service; and a media selection service.

6. The method of claim 1 further comprising: when the at least one occupant is identified as a driver and the vehicle is not moving, allowing the driver to use the vehicular service.

7. The method of claim 6 further comprising subsequently determining that the vehicle is again moving and when the at least one occupant is identified as a driver, the vehicle is again moving, and when the communication could result in driver distraction, preventing the driver from using the vehicular service.

8. A method of preventing driver distraction in a vehicle, the method comprising:
receiving a voice command from a user of a vehicle;
determining whether the received voice command requires a distracting interaction of the user, the interaction being a complex physical response of the user;
determining whether the vehicle is moving;
analyzing the voice command to determine whether the user associated with the voice command is a driver of the vehicle;
when the vehicle is moving, the execution of the voice command would result in user distraction, and the user is the driver, disabling execution of the voice command;
when the vehicle is moving, execution of the voice command would result in user distraction, and the user is not the driver; allowing execution of the voice command.

9. The method of claim 8 wherein analyzing the voice command comprises determining an identity of the user based at least in part on a signal origination of the voice command.

10. The method of claim 8 wherein analyzing the voice command comprises determining an identity of the user based at least in part by using a speaker identification approach to analyze the voice command.

11. The method of claim 8 wherein the execution of the voice command requires use of a service, the service selected from the group consisting of: a voice communication service; a navigation system service; an information display service; and a media selection service.

12. An apparatus of preventing driver distraction in a vehicle, the apparatus comprising:
an interface with an input and an output, the input configured to receive at least one communication from at least one occupant in a vehicle and a signal indicative of whether the vehicle is moving, the output coupled to a vehicular service module;
a controller, the controller coupled to the interface, the controller configured to determine the identity of the at least one occupant that made the at least one communication and determine whether the vehicle is moving based upon the signal, the controller being further configured to when the at least one occupant is identified as a driver, the vehicle is moving, and when the communication could result in driver distraction, send a first signal to the vehicular services module via the output that is effective to prevent the driver from using the vehicular service module, the controller further configured to when the at least one occupant is identified as a non-driver and the vehicle is moving, send a second signal to the vehicular services module via the output that is effective to allow the non-driver to utilize the vehicular service module.

13. The apparatus of claim 12 wherein the controller is configured to determine the identity of the at least one occupant from voice signals received from a plurality of microphones and determine the identity based at least in part on the strength of the voice signals.

14. The apparatus of claim 12 wherein the controller is configured to determine the identity of the at least one occupant from voice signals received from a plurality of microphones and use a speaker identification approach to determine the identity of the voice signals.

15. The apparatus of claim 12 wherein the vehicular service module provides a service selected from the group consisting of: a voice communication service; a navigation system service; an information display service; and a media selection service.

16. The apparatus of claim 12 wherein the controller is configured to when the at least one occupant is identified as a driver and the vehicle is not moving, send a third signal to the vehicular services module via the output that is effective to allow the driver to use the vehicular service module.

17. The apparatus of claim 16 wherein the controller is configured to subsequently determine that the vehicle is again moving and when the at least one occupant is identified as a driver and the vehicle is again moving, send a fourth signal to the vehicular services module via the output that is effective to prevent the driver from using the vehicular service module.
